(19) United States
(12) Patent Application Publication
(10) Pub. No.: US 2022/0250985 A1
(43) Pub. Date: Aug. 11, 2022

(54) BINDER FOR INSULATION AND NON-WOVEN MATS

(71) Applicant: LRBG Chemicals Inc., Longueuil (CA)

(72) Inventor: Alexander Tseitlin, Acton (CA)

(21) Appl. No.: 17/630,456

(22) PCT Filed: Jul. 29, 2020
(86) PCT No.: PCT/IB2020/057178

§ 371 Date: Jan. 26, 2022

Related U.S. Application Data
(60) Provisional application No. 62/880,053, filed on Jul. 29, 2019.

(51) Int. Cl. C04B 26/18; C04B 26/28; C04B 14/42

(52) U.S. Cl. CPC C04B 26/18; C04B 40/0263; C04B 14/42; C04B 26/28

(57) ABSTRACT

A fibrous material is treated with a binder solution and then heated. The binder comprises a polyester and a biopolymer, such as starch, where the polyester is a product of reaction of a polyol with an anhydride. A method for manufacturing the treated fibrous material comprises treating it with the binder solution and then heating. A cross-linking agent may be added.

### RELATED APPLICATIONS

This application claims the benefit of priority to the U.S. Provisional Application No. 62/880,053, filed on Jul. 29, 2019, which is incorporated herein by reference in its entirety.

### BACKGROUND

The disclosure pertains, without limitation, to self-setting thermosetting binder compositions used for coating or impregnating fibers or fibrous materials and for manufacturing fiberglass insulation, non-woven mats, and other materials, including building materials.

Mineral fibers typically used in insulation products and non-woven mats are usually bonded together with crosslinked binder resins. The binder provides the resilience for recovery after packaging as well as the stiffness and compatibility between individual fibers.

The process for making fiberglass insulation typically includes drawing of molten polymer, glass, minerals, or other suitable substances onto spinning wheels where they are spun into thin fibers by the centrifugal force. The fibers may then be blown to a conveyor through a forming chamber where they may be sprayed with an aqueous binder. Thereafter, the coated mat may be transferred to a curing oven to cure binder and bond the fibers together.

The common binders for insulation and non-woven mats include formaldehyde-based resins (e.g., phenol-formaldehyde, melamine-formaldehyde, and urea-formaldehyde). One disadvantage of using formaldehyde-based resins is the high quantity of free formaldehyde involved which is undesirable for human health and environmental reasons.

High-strength fiber mats are widely used in the building materials industry and beyond. Non-woven fiber mats have numerous applications, such as roofing, siding, floor underlayment, insulation facers, floor and ceiling tile, and vehicle parts.

Because building materials, generally, and roofing shingles, in particular, are often subjected to a variety of adverse weather conditions, such as extreme heat or cold, hail, rain, snow, etc., the fiber mats should also maintain their strength characteristics under a wide range of such adverse conditions.

### BRIEF SUMMARY

The disclosed methods, products, and materials include or use a curable aqueous composition comprising a combination of a biopolymer (such as modified water-soluble starch and/or wheat flour) with a polyester produced by a reaction of a polyol with an organic anhydride. A multi-functional crosslinking agent, which may be one or more of polyacids, anhydrides, polyols, functionalized silanes, or their mixtures, may be added to the binder.

The polyols include a variety of materials including, but not limited to, ethylene glycol (e.g., to make 2,3-dihydroxydioxane), diethylene glycol, dialkylene glycol (e.g., to make oligomeric condensation products), such as 1,2-propylene glycol, 1,3-propylene glycol, 1,2-butylene glycol, 1,3-butylene glycol, 1,4-butylene glycol, and/or one or more polyethylene glycols having formulas HO(CH₂CH₂O)ₙH where n is from 1 to about 50, silanols (such as products of hydrolysis of organosiloxanes), and the like, and their mixtures. Other suitable polyols containing at least three hydroxy groups may also be used, for example, glycerin (e.g., to make 2,3-dihydroxy-5-hydroxymethyl dioxane), as well as unalkylated or partially alkylated polymeric glyoxal derived glycols, such as poly (N-1′,2′-dihydroxyethyl-ethylene urea), dextrans, glyceryl monostearate, ascorbic acid, erythrobic acid, sorbic acid, ascorbyl palmitate, calcium ascorbate, calcium sorbate, potassium sorbate, sodium ascorbate, sodium sorbate, monoglycerides of edible fats or oils or edible fat-forming acids, inositol, sodium tartrate, sodium potassium tartrate, glycerol monocaprate, sorbose monoglyceride citrate, polyvinyl alcohol, α-D-methylglucoside, carbohydrates, sorbitol, or dextrose, and their mixtures.

The anhydrides may be anhydrides of the nonpolymeric polyacids. These anhydrides include maleic anhydride, succinic anhydride, phthalic anhydride, and the like and combinations thereof.

The binder may also comprise a co-crosslinker and coupling agent, such as a silane or silanes of the following general formula: R¹ₙSi(OR²)₄₋ₙ, where R¹ and R² are methyl, ethyl, or any organic radical.

The methods, products and materials also include or use a cured composition comprising a nonwoven fiber and a cured binder wherein the cured composition is formed by mixing fibers in a curable aqueous composition to form a mixture and then temperature-curing the mixture.

The methods, products and materials also include a method for forming a non-woven material comprising mixing fibers with a curable aqueous composition including the binder, for example, by spraying the fibers, and heating the curable composition and fibers at a temperature of between 180° C. and 230° C. for sufficient time to cure.

Preferably, the binder comprises up to 60% of water by weight immediately prior to curing. Most preferably, the binder comprises 45 to 65% of water by weight immediately prior to curing.

The binder may optionally to improve its strength comprise polyacids having at least two acidic functional groups that react with alcohol moieties on the starch particles. One option is to use nonpolymeric polyacids. These nonpolymeric polyacids include citric acid, maleic acid, succinic acid, phthalic acid, glutaric acid, malic acid, phthalic acid, or the like, salts thereof, and combinations thereof.

The curable aqueous composition including the binder may also include other components, e.g., urea to improve strength and water resistance, emulsifiers to promote mixability, plasticizers, antifoaming agents, biocide additives, anti-mycosis agents including, e.g., fungicides and mold inhibitors, adhesion promoting agents, colorants, waxes, or antioxidants, and combinations thereof.

The curable aqueous composition including the binder may also be used to prepare nonwoven products by a variety of methods which may involve impregnation of a loosely assembled mass of fibers with a binder solution to form a mat. The fibers may comprise natural fibers, such as cellulose, wool, jute, synthetic fibers, such as polyesters, acrylics, nylon, polyamides, ceramics, glass fibers, mineral wool, fiberglass, polymer fibers, mineral fibers, paper fibers, textile fibers, and the like, alone or in combinations.

The product may be used for coating or impregnating fibrous materials, such as paper, loose fibers, connected fibers, compressed fibers, woven fibers, non-woven fibers, textiles, building insulation, roofing fiberglass mats, or nonwoven filtration materials.

The fibrous material may be immersed into, dispersed with, coated, mixed, sprayed, or impregnated with the binder.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### DETAILED DESCRIPTION

The disclosed self-setting thermosetting formaldehyde-free binder compositions and systems based on interpenetrating networks of polyesters and biopolymers do not emit formaldehyde, do not corrode equipment used in their manufacturing, are stable (i.e. do not require being prepared immediately before their use), reduce total emissions, and are environmentally friendly. They may be used for manufacturing low cost, low corrosivity, low viscosity, rigid materials, which do not have to have dark color. It should be noted that starch is generally much cheaper than pure polyester by weight.

The binder also improves wet web strength of wet mats (such as glass mats) before curing, improves the production line speed, lowers the vacuum drawing requirements during the production, and provides adequate dry mat tensile strengths (for example, to improve the ability of the finished roofing product to resist stresses during its service on the roof).

Sample 1. Polyester Binder I.

An anhydride was dissolved in water at the temperature of 90-95° C.; then, after cooling, polyvinyl alcohol and starch were added at 60° C.; the mixture was heated to 90° C. and mixed until the mix became homogeneous. After cooling, urea was added at 60° C., the mixture was heated to 80° C., and mixed at this temperature for 30 min. The mixture then cooled down to 50° C., a crosslinker was added, and the mixture was cooled down to a room temperature.

Sample 2. Polyester Binder II.

An anhydride was dissolved in water at the temperature of 90-95° C.; then, after cooling, polyvinyl alcohol was added at 60° C.; the mixture was heated to 90° C. and mixed until the mix became homogeneous. After cooling, urea was added at 60° C., the mixture was heated to 80° C., and mixed at this temperature for 30 min. The mixture then cooled down to 50° C., a crosslinker was added, and the mixture was cooled down to a room temperature.

Sample 3. Polyester/Biopolymer Binder.

A modified starch was dissolved in water using mechanical agitation for 15 to 60 minutes at 45° C. using a 3-blade mixer at 200 rpm. In a separate vessel, polyvinyl alcohol was dissolved in water and maleic and phthalic anhydride were added at 60° C., the mixture was then heated to 90° C. Both solutions were mixed together at 60° C., a crosslinker was added, and the mixture cooled down to a room temperature. The obtained binder is a low-viscosity transparent liquid.

Tensile testing of cured glass fiber specimens.

The polyester/biopolymer binder of Sample 3 was diluted with water to produce a binder solution having 5% non-volatiles.

A phenol-urea-formaldehyde (PUF) binder was used for comparison

Glass microfiber paper (Whatman 934-AH) samples were soaked in each of the four binder solutions for 5 minutes, then the excess liquid was removed by vacuuming. The paper samples were put into an oven at 200° C. for 5 minutes to cure the binder resin.

The cured samples were cut into specimens having the dimensions of 6″×1″ and tested for dry tensile strength using an Instron tensile tester.

For wet tensile testing, the specimens were subsequently treated with hot water at 80° C. for 10 minutes, and then tested again for tensile strength while still wet. The retention was calculated as the wet strength to dry strength ratio. The load in kilogram-force (kgf) was measured at the break. The test results are presented in Table 1.

TABLE 1

| Binder | Dry strength, kgf | Wet strength, kgf | Retention, % |
|---|---|---|---|
| PUF | 6.398 | 5.772 | 90.2 |
| Polyester Sample I | 6.895 | 5.760 | 83.5 |
| Polyester Sample II | 8.251 | 7.172 | 86.9 |
| Polyester/Biopolymer | 6.976 | 5.617 | 80.5 |

It should be understood that the description and specific examples are given by way of illustration only, since various changes and modifications within the spirit and scope of the disclosure will become apparent to those skilled in the art from this disclosure.

While this invention has been particularly shown and described with references to preferred embodiments thereof, it will be understood by those skilled in the art that various changes in form and details may be made therein without departing from the scope of the invention encompassed by the appended claims.

1. An article of manufacture comprising:
fibrous material treated with a binder,
wherein the binder comprises:
a polyester or polyester copolymer, and
a biopolymer.

2. The article of claim 1,
wherein the article is a mat.

3. The article of claim 1,
wherein the fibrous material comprises paper, loose fibers, connected fibers, compressed fibers, woven fibers, non-woven fibers, or a combination thereof.

4. The article of claim 1,
wherein the fibrous material comprises mineral wool, fiberglass, polymer fibers, glass fibers, mineral fibers, paper fibers, textile fibers, natural fibers, organic fibers, synthetic fibers, cellulose, wool, jute, polyester, acrylic, nylon, polyamide, ceramics, or a combination thereof.

5. The article of claim 1,
wherein the fibrous material is being immersed into, dispersed with, coated, mixed, sprayed, or impregnated with the binder.

6. The article of claim 1,
wherein the treated fibrous material is temperature-cured.

7. The article of claim 1,
wherein the treated fibrous material is temperature-cured at a temperature of between 180° C. and 230° C.

8. The article of claim 1,
wherein the fibrous material is treated with the binder combined with a liquid.

9. The article of claim 8,
wherein the binder weight is 45 to 65% of liquid weight.

10. The article of claim 1,
wherein the fibrous material is treated with the binder combined with water to form a solution.

11. The article of claim 1,
wherein the binder further comprises a cross-linking agent.

12. The article of claim 11,
wherein the cross-linking agent comprises a polyacid, anhydride, polyol, functionalized silane, or a combination thereof.

13. The article of claim 1,
wherein the binder further comprises a co-cross-linking or coupling agent,
wherein the cross-linking or coupling agent comprises a polyacid, anhydride, polyol, functionalized silane, a silane of general formula R¹ₙSi(OR²)₄₋ₙ, or a combination thereof, and
wherein R¹ and R² are methyl, ethyl, or any organic radical.

14. The article of claim 1,
wherein the biopolymer comprises starch, modified starch, water-soluble starch, flour, wheat flour, or a combination thereof.

15. The article of claim 1,
wherein the polyester or polyester copolymer is a product of reaction of a polyol or polyol compound with an anhydride or anhydride compound.

16. The article of claim 15,
wherein the polyol or polyol compound comprises ethylene glycol, diethylene glycol, dialkylene glycol, 1,2-propylene glycol, 1,3-propylene glycol, 1,2-butylene glycol, 1,3-butylene glycol, 1,4-butylene glycol, polyethylene glycol of general formula HO(CH₂CH₂O)ₙH, where n is from 1 to 50, silanols, products of hydrolysis of organosiloxanes, polyols containing at least three hydroxy groups, glycerin, as well as unalkylated or partially alkylated polymeric glyoxal derived glycols, poly (N-1′,2′-dihydroxyethyl-ethylene urea, dextrans, glyceryl monostearate, ascorbic acid, erythrobic acid, sorbic acid, ascorbyl palmitate, calcium ascorbate, calcium sorbate, potassium sorbate, sodium ascorbate, sodium sorbate, monoglycerides of edible fats or oils or edible fat-forming acids, inositol, sodium tartrate, sodium potassium tartrate, glycerol monocaprate, sorbose monoglyceride citrate, polyvinyl alcohol, α-D-methylglucoside, carbohydrates, sorbitol, dextrose, or a combination thereof.

17. The article of claim 15,
wherein the anhydride or anhydride compound comprises an anhydride of a nonpolymeric polyacid, maleic anhydride, succinic anhydride, phthalic anhydride, or a combination thereof.

18. The article of claim 1,
wherein the binder further comprises a polyacid having at least two acidic functional groups that react with alcohol moieties on starch particles, nonpolymeric polyacids, citric acid, maleic acid, succinic acid, phthalic acid, glutaric acid, malic acid, phthalic acid, salts thereof, or a combination thereof.

19. The article of claim 1 wherein the binder further comprises urea.

20. A method comprising:
treating fibrous material with a binder,
wherein the binder comprises:
a polyester or a polyester copolymer, and
a biopolymer.

21. The article of claim 20,
wherein the article is a mat.

22. The article of claim 20,
wherein the fibrous material comprises paper, loose fibers, connected fibers, compressed fibers, woven fibers, non-woven fibers, or a combination thereof.

23. The article of claim 20,
wherein the fibrous material comprises mineral wool, fiberglass, polymer fibers, glass fibers, mineral fibers, paper fibers, textile fibers, natural fibers, organic fibers, synthetic fibers, cellulose, wool, jute, polyester, acrylic, nylon, polyamide, ceramics, or a combination thereof.

24. The article of claim 20,
wherein the fibrous material is being immersed into, dispersed with, coated, mixed, sprayed, or impregnated with the binder.

25. The article of claim 20,
wherein the treated fibrous material is temperature-cured.

26. The article of claim 20,
wherein the treated fibrous material is temperature-cured at a temperature of between 180° C. and 230° C.

27. The article of claim 20,
wherein the fibrous material is treated with the binder combined with a liquid.

28. The article of claim 27,
wherein the binder weight is 45 to 65% of liquid weight.

29. The article of claim 20,
wherein the fibrous material is treated with the binder combined with water to form a solution.

30. The article of claim 20,
wherein the binder further comprises a cross-linking agent.

31. The article of claim 30,
wherein the cross-linking agent comprises a polyacid, anhydride, polyol, functionalized silane, or a combination thereof.

32. The article of claim 20,
wherein the binder further comprises a co-cross-linking or coupling agent,
wherein the cross-linking or coupling agent comprises a polyacid, anhydride, polyol, functionalized silane, a silane of general formula R¹ₙSi(OR²)₄₋ₙ, or a combination thereof, and
wherein R¹ and R² are methyl, ethyl, or any organic radical.

33. The article of claim 20,
wherein the biopolymer comprises starch, modified starch, water-soluble starch, flour, wheat flour, or a combination thereof.

34. The article of claim 20,
wherein the polyester or polyester copolymer is a product of reaction of a polyol or polyol compound with an anhydride or anhydride compound.

35. The article of claim 34,
wherein the polyol or polyol compound comprises ethylene glycol, diethylene glycol, dialkylene glycol, 1,2-propylene glycol, 1,3-propylene glycol, 1,2-butylene glycol, 1,3-butylene glycol, 1,4-butylene glycol, polyethylene glycol of general formula HO(CH₂CH₂O)ₙH, where n is from 1 to 50, silanols, products of hydrolysis of organosiloxanes, polyols containing at least three hydroxy groups, glycerin, as well as unalkylated or partially alkylated polymeric glyoxal derived glycols, poly (N-1′,2′-dihydroxyethyl-ethylene urea, dextrans, glyceryl monostearate, ascorbic acid, erythrobic acid, sorbic acid, ascorbyl palmitate, calcium ascorbate, calcium sorbate, potassium sorbate, sodium ascorbate, sodium sorbate, monoglycerides of edible fats or oils or edible fat-forming acids, inositol, sodium tartrate, sodium potassium tartrate, glycerol monocaprate, sorbose monoglyceride citrate, polyvinyl alcohol, α-D-methylglucoside, carbohydrates, sorbitol, dextrose, or a combination thereof.

36. The article of claim 34,
wherein the anhydride or anhydride compound comprises an anhydride of a nonpolymeric polyacid, maleic anhydride, succinic anhydride, phthalic anhydride, or a combination thereof.

37. The article of claim 20,
wherein the binder further comprises a polyacid having at least two acidic functional groups that react with alcohol moieties on starch particles, nonpolymeric polyacids, citric acid, maleic acid, succinic acid, phthalic acid, glutaric acid, malic acid, phthalic acid, salts thereof, or a combination thereof.

38. The article of claim 20 wherein the binder further comprises urea.
